(19) United States
(12) Patent Application Publication
(10) Pub. No.: US 2026/0038123 A1
(43) Pub. Date: Feb. 5, 2026

(54) Method and device for detecting at least one instance of an object during a work process in a work environment

(71) Applicant: SICK AG, Waldkirch (DE)

(72) Inventors: Markus BOEHNING, Hamburg (DE); Felix WARMUTH, Hamburg (DE); Christoph ECKERT, Hamburg (DE)

(21) Appl. No.: 19/286,546

(22) Filed: Jul. 31, 2025

(30) Foreign Application Priority Data
Aug. 2, 2024 (DE) 102024122058.9

(51) Int. Cl. G06T 7/11; B25J 9/16; B25J 19/02; G06K 7/14; G06T 7/73

(52) U.S. Cl. CPC G06T 7/11; B25J 9/161; B25J 9/1612; B25J 9/163; B25J 19/023; G06K 7/1417; G06T 7/73; G06T 2207/20084

(57) ABSTRACT

The invention relates to a method for recognizing at least one instance of an object during a work sequence in a working environment, said method comprising the steps (A) recording an image of the working environment by means of a camera apparatus, (B) transmitting the image to a monitoring and control unit, (C) detecting a predefined or predefinable starting region for the segmenting of the instance in the image, whereby the instance is selected by the monitoring and control unit for the segmenting, and (D) segmenting the instance in the image, starting from the starting region that is detected and that is arranged within the instance, by means of the monitoring and control unit and recognizing the segmented instance.

The invention relates to a method and an apparatus for recognizing at least one instance of an object during a work sequence in a working environment.

In stationary applications and work sequences in which the conditions change continuously over time, such as the palletizing and depalletizing of goods or packages, 2D and/or 3D sensor systems mounted in a stationary manner are often used to recognize the goods or packages on belts and pallets, to segment individual instances of the goods or packages, and to determine the best gripping coordinates for gripping the instances for a robot arm.

For example, algorithms that are based on the detection of edges (“edge detection”) in the image data or on a comparison with predefined object shapes (“CAD matching”) can be used for the segmenting. Neural networks trained based on annotated data can also be used to segment the image data. In this respect, the quality of the segmenting can be improved by providing advance information.

The marking of a region of interest, the selection of positive and negative points for marking a region inside or outside an instance or the provision of object dimensions can be named as examples here. However, in particular when using positive and negative points as advance information, this requires a manual marking of each individual instance by a person with specialist knowledge. This makes the segmenting time-consuming and inefficient and is therefore not an option for automated instance segmenting tasks of a priori unknown objects.

It is therefore an object of the invention to provide an improved method and an apparatus that enable a simple, fast, efficient and cost-effective recognition of an instance of an object during a work sequence in a working environment.

This object is satisfied in a first aspect of the invention by a method having the features of claim 1, and in particular in that the method comprises the steps:
recording an image of the working environment by means of a camera apparatus,
transmitting the image to a monitoring and control unit,
detecting a predefined or predefinable starting region for the segmenting of the instance in the image, whereby the instance is selected by the monitoring and control unit for the segmenting,
segmenting the instance in the image, starting from the starting region that is detected and that is arranged within the instance, by means of the monitoring and control unit and recognizing the segmented instance.

The method serves to recognize at least one instance of an object during a work sequence in a working environment. In this application, the working environment is defined as a three-dimensional region that is required during the work sequence. The work sequence can here comprise a series of similar and/or different work steps. The working environment can, for example, be a region of a room, a hall or a warehouse in which a work sequence, in which the conditions change continuously over time, is carried out.

The work sequence can, for example, comprise a palletizing or depalletizing of goods or packages, bin picking or the loading and unloading from a conveyor belt. In this respect, it is necessary to recognize individual instances, i.e. individual goods or packages, and to record their position and geometric dimensions, for example. The instances can differ in their shape and/or size, but they can all be assigned to the same “goods” or “package” object.

According to the method, an image of the working environment is recorded in a first step. The camera apparatus used for this purpose can be mounted in a stationary manner and can comprise 2D and/or 3D sensor systems for monitoring the working environment. The image can generally contain a plurality of instances, wherein, depending on the arrangement and/or orientation of the instances, the respective predefined or predefinable starting region is recognizable or detectable or not recognizable or detectable in the image. However, at least one instance will generally be arranged such that the monitoring and control unit can detect the starting region within the instance.

The starting region can be a marking that is applied to the instance and that can be detected and recognized in the image of the instance by the monitoring and control unit. The starting region can be structured and can in particular have an inhomogeneous brightness distribution. The starting region forms a positive point or a positive marking for the instance that is currently selected and is subsequently segmented. At the same time, the starting region for the current segmenting step forms a negative point or a negative marking for all other possible instances in the image.

After the image of the working environment has been transmitted to the monitoring and control unit, the monitoring and control unit captures and detects the starting region of any desired instance in the image and thereby selects said instance for the subsequent step of segmenting. In other words, due to the detecting of the starting region, a positive point is set as advance information in/for the image of the instance and selects the instance for the segmenting. At the same time, the detected starting region acts as a negative point for all other instances in the image that are thus excluded from the current segmenting step. Once the instance has been selected, the monitoring and control unit segments the instance in the image, starting from the detected starting region. The segmented image of the instance can now be used to determine parameters of the instance, such as the position, orientation or further geometric features or dimensions, and to transfer them to a working apparatus in order to perform a work process on the instance.

The method can be continued with the step of detecting a starting region in a further instance and the subsequent segmenting of said instance in the image. The repetition of these two steps can in principle take place until all the instances have been segmented whose position and orientation enable a detection and recognition of the starting region in the respective instance.

However, since the position and orientation of the instances can change during the work sequence, the image is in general only used for segmenting a single instance or some few instances and is then replaced by a further, more up-to-date image. In this case, the method again starts with the step of recording an image of the working environment, followed by the transfer of this image to the monitoring and control unit and the subsequent detection of a starting region.

Due to the detecting of the starting region, the method enables a simple, fast, efficient and cost-effective recognition of an instance of an object during a work sequence in a working environment.

The method can be used in all logistics-related applications, for example in the order picking and order decommissioning such as bin picking, palletizing, depalletizing and in track & trace applications. In more general terms, the method can be applied to any application that is based on a visual perception.

According to one embodiment, the detecting of the starting region in the image of the working environment takes place automatically by the monitoring and control unit.

According to one embodiment, the segmenting of the instance in the image takes place in a fully automatic and interaction-free manner.

The segmenting of the instance can thus be completely automated and in particular does not require any interaction by a person with specialist knowledge. For example, it is no longer necessary to manually set positive points as advance information in the image of the instance, for example by clicking on the corresponding position, in order to select the instance for the segmenting. The method is thus also suitable for automated instance segmenting tasks of a priori unknown objects.

According to an embodiment, the starting region in the image of the working environment comprises an area that is smaller than the area of the instance in the image of the working environment, in particular wherein the area of the starting region is smaller than 80%, preferably smaller than 60%, of the area of the instance. The starting region can be considerably smaller than the instance within whose boundaries said starting region is located in terms of area and for whose segmenting said starting region serves as a positive point or positive marking. For example, the starting region can be a small marking that is applied to the instance and that can be detected and recognized by the control and monitoring unit. It is understood here that the starting region should not fall below a lower limit of its areal extent in the image in order to ensure a reliable detection by the control and monitoring unit.

According to one embodiment, the starting region and the instance in the image of the working environment differ in the shape and/or the brightness distribution and/or the histogram of the brightness values and/or the cumulative histogram of the brightness values. The brightness value can, for example, be the intensity value of a picture element or pixel of the image. The starting region and the image of the instance outside the starting region in particular differ in the aforementioned features. The starting region and the instance thus do not appear similar in the image. The starting region consequently does not serve as a reference or template to segment the instance as part of “Template Matching” or “Matched Filter” methods, but can differ from the instance in terms of structure, shape and brightness. In this way, the starting region serves purely as a positive marking by means of which the instance is selected for the segmenting, and not as a reference region for the segmenting per se. The starting regions of different detected instances can in turn have a self-similar structure, shape or brightness distribution. The starting regions can thus be regarded as positive markings that can be assigned to the same class, but may differ in detail.

According to one embodiment, the starting region is a coded marking, in particular a barcode or a QR code. Such coded markings are often applied by default to be able to identify and assign objects or their instances. In this respect, the position and orientation of the marking can in general be determined with great accuracy. The method can now use this marking already present on the instance to select and segment the instance. In this respect, only the coded marking must be recognized and detected as such; on the other hand, a reading out and/or a decoding of the individual data coded in the marking is/are not required for the detection of the selection region. Markings that are anyway present as standard and are applied to the instances can thus additionally be used for a cost-effective, robust and efficient segmenting of the instances.

According to one embodiment, the monitoring and control unit comprises a neural network, wherein the neural network receives an object description, in particular a text-based and/or audio-based object description, of the starting region, decodes and converts the object description into an image representation, and detects the starting region for the segmenting of the instance on the basis of the object description converted into an image representation in the image of the working environment. The object description can also comprise components that are already represented as images and thus already have an image form. The advance information provided by the starting region is thus not limited to geometric information such as positive and negative points, regions of interest and in particular not to positions of coded markings. Rather, the advance information can comprise a textual object description that can be used as an input for segmenting models that combine images and text by means of neural networks.

According to one embodiment, a predefined orientation and/or a predefined position of the detected starting region at the instance is/are used as additional information for the segmenting of the instance. Markings are often arranged on the instances at predefined positions and with a predefined orientation, for example parallel to an edge or to a plurality of edges of the instance. This information can additionally be used by the control and monitoring unit to further improve the detecting of the starting region and the segmenting of the instance and to make it even more efficient.

According to one embodiment, the image is a two-dimensional or a three-dimensional image of the working environment. The camera apparatus can, for example, be a 2D RGB camera, a 3D time-of-flight (ToF) camera or a 3D stereo camera. The 3D cameras provide image data that have additional depth information. This depth information is not necessary for the sequence of the method, but can enable the determination of more precise geometric parameters or features of the instance for the working apparatus after a segmenting has taken place, for example the determination of better gripping coordinates for an arm of a robot.

According to one embodiment, the method furthermore comprises the determination of geometric features, in particular of the position and/or extent and/or orientation, of the segmented instance, in particular wherein the determined geometric features are transmitted to a working apparatus. The working apparatus can, for example, be a robot to which gripping coordinates are transmitted for gripping the instance, for example during bin picking or as part of a palletizing or a loading or unloading of a conveyor belt.

The object is furthermore satisfied in a second aspect of the invention by an apparatus according to claim 11, and in particular in that the apparatus has a camera apparatus and a monitoring and control unit, wherein the camera apparatus is configured to record an image of the working environment and to transmit it to the monitoring and control unit, wherein the monitoring and control unit is configured to detect, in particular to automatically detect, a predefined or predefinable starting region within the instance in the image of the working environment and, as a result, to select an instance for the segmenting of the instance, and wherein the monitoring and control unit is configured to recognize the instance in the image by means of a segmenting, wherein the instance is segmented, starting from the starting region that is detected and that is arranged within the instance, in particular wherein the segmenting of the instance in the image takes place in a fully automatic and interaction-free manner.

The apparatus according to the invention and its embodiments are configured to carry out the method according to the invention or one of its embodiments. The statements on the method and its embodiments apply accordingly.

Accordingly, the monitoring and control unit of the apparatus is configured to detect a starting region of any desired instance in the image and to select it for a subsequent segmenting. The monitoring and control unit is furthermore configured, after the selection has taken place, to segment the instance in the image, starting from the detected starting region. The apparatus thus enables a simple, fast, efficient and cost-effective recognition of an instance of an object during a work sequence in a working environment.

According to one embodiment, the monitoring and control unit is furthermore configured to determine geometric features of the segmented instance, in particular the position and/or extent and/or orientation, in particular wherein the geometric features are transmitted to a working apparatus. The working apparatus can, for example, be a robot to which gripping coordinates for gripping the instance are transmitted, for example during bin picking or as part of a palletizing or a loading or unloading of a conveyor belt.

The object is furthermore satisfied in a third aspect of the invention by a system for controlling a work sequence in a working environment, said system comprising an apparatus according to claim 11 or 12, a working apparatus, in particular a robot, which is configured to carry out steps of the work sequence, and a control apparatus that is configured to calculate control parameters for the working apparatus based on geometric features transmitted by the apparatus and to transmit said control parameters to the working apparatus. The control apparatus can be an integral part of the apparatus or can be arranged separately from the apparatus. The control parameters can, for example, comprise coordinates such as optimal gripping coordinates for the gripping of the instance by a robot arm.

According to one embodiment, the control apparatus is configured to calculate the control parameters from geometric features, which are transmitted by the apparatus, by means of a neural network. This enables a fast and precise calculation of the control parameters from the geometric features of the instance, which speeds up the work sequence and improves its quality.

The invention will be explained only by way of example with reference to the Figures in the following.

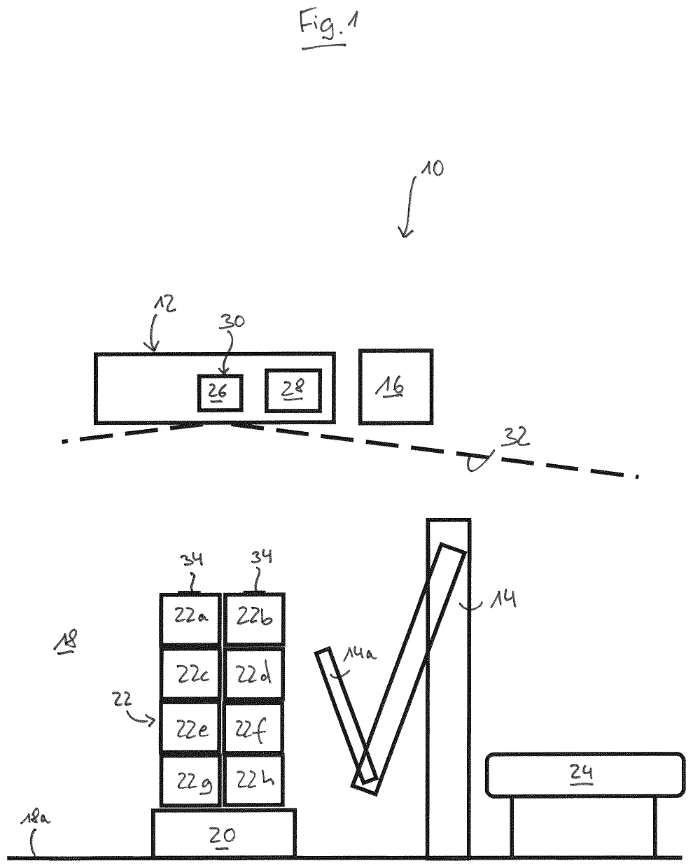

FIG. 1 shows an embodiment of the system according to the invention in a schematic representation in a side view; and

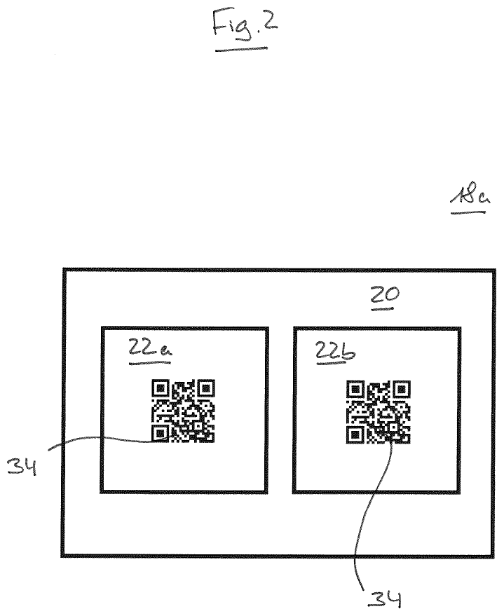

FIG. 2 shows a detail of the working environment of FIG. 1 in a top view.

FIGS. 1 and 2 show an embodiment of a system 10 according to the invention in schematic representations. The system 10 comprises an apparatus 12 for recognizing an instance of an object, a working apparatus 14, shown schematically as a robot here, and a control apparatus 16. The system 10 is located in a hall 18 that forms a working environment. A pallet 20, which is loaded with goods packages 22 and which is to be unloaded, is located on the floor 18a of the hall 18. For this purpose, the instances 22a to 22h of the goods packages 22 stacked above one another are successively lifted from the pallet 20 by an arm 14a of the robot 14 and are positioned on a conveyor belt 24.

The apparatus 12 comprises a camera apparatus 26 and a monitoring and control unit 28. The camera apparatus 26 is arranged above the pallet 20 and includes an image sensor 30 in which a plurality of picture elements are arranged and which is configured to generate a two-dimensional image of the working environment 18. The image sensor 30 can, for example, be a 2D RGB camera. The camera apparatus 26 is configured to record a continuous sequence of image data of a region 32 of the working environment 18 by means of the image sensor 30.

As can be seen in the top view shown in FIG. 2 of the pallet 20 loaded with goods packages 22, a respective QR code 34 is applied to the top side of the goods packages 22 facing the camera apparatus 26. The QR code 34 can be identical for the individual instances 22a to 22h of the goods packages 22 or can also be individually formed and differ from instance to instance.

The monitoring and control unit 28 is configured to select any desired instance of the goods packages 22, for example the instance 22b, in an image of the working environment 18 transmitted by the camera apparatus 26 in that said monitoring and control unit 28 detects the QR code 34 lying within the area of the instance 22b as the starting region for a segmenting. The monitoring and control unit 28 is furthermore configured, after a selection has taken place, to segment the instance 22c in the image, starting from the detected starting region 34, and to determine geometric features such as the position and/or extent and/or orientation of the segmented instance 22c.

The control apparatus 16 is configured to calculate control parameters for the working apparatus 14 based on geometric features of the instance 22c transmitted by the apparatus 12 and to transmit said control parameters to the working apparatus 14.

One embodiment of the method for recognizing at least one instance of an object during a work sequence in a working environment is explained with reference to the system 10 of FIGS. 1 and 2.

The work sequence comprises removing individual instances 22a to 22h of goods packages 22 from a pallet 20 and positioning the removed instances on a conveyor belt 24. At the early first point in time of the work sequence shown in FIG. 1, there are still many instances 22a to 22h of goods packages 22 on the pallet 20. During the unloading of the pallet 20, the working environment 18 and in particular the pallet 20 loaded with goods packages 22 is monitored by the camera apparatus 12. A sequence of image data of a region 32 of the working environment 18 is generated in this respect. These image data represent a current image of the working environment 18 in each case.

At the beginning of the unloading of the pallet 20, a current image of the working environment 18 is transmitted to the monitoring and control unit 28 that analyzes the image and searches in the image for starting regions 34 that are each formed by a QR code 34. In the present example, the monitoring and control unit 28 will determine that two possible starting regions have been recognized on the instances 22a and 22b in the image. The monitoring and control unit 28 now selects one of the two detected QR codes as the starting region 34 for a subsequent segmenting, whereby that instance, for example the instance 22b, was selected for the subsequent segmenting process. The starting region 34 thus forms an automatically set positive point or positive marking for the instance 22b that is now currently selected and is subsequently segmented. At the same time, the starting region 34 for the current segmenting process forms a negative point or negative marking for the second possible instance 22a in the image, whereby said instance is excluded from the current segmenting process.

After the instance 22b has been selected, the instance 22b is segmented in the image of the working environment 18, starting from the detected QR code 34, by the monitoring and control unit 28 and is thereby recognized. After the segmenting process has been completed, the monitoring and control unit 28 determines geometric features such as the position and/or extent and/or orientation of the segmented instance 22b and transmits this information to the control apparatus 16. Based on the geometric features transmitted by the monitoring and control unit 28, the control apparatus 16 calculates control parameters and transmits them to the robot 14. The control parameters can, for example, comprise optimal gripping coordinates for gripping the instance 22b on the pallet 20. To determine the control parameters, the control apparatus 16 can have a neural network that performs tasks such as the determination of three-dimensional coordinates. The calculated control parameters can be transmitted in a wired or wireless manner to the host of the robot 14.

After the instance 22b has been removed from the pallet 20 and lifted onto the conveyor belt 24, the method can be repeated until the pallet 20 has been completely unloaded. In this respect, the recognition of the instance 22a can take place on the same image on which the instance 22b has already been recognized. Alternatively, the recognition of the instance 22a can take place on a current image that was recorded after the image on which the instance 22b was recognized. In particular for the recognition of further instances 22c to 22f, the transmission of a further current image to the monitoring and control unit 28 is absolutely necessary for the detection of the QR codes applied there.

The method enables a fast, efficient and cost-effective recognition of instances of an object during a work process. The segmenting of the instance can in particular be completely automated and thus does not require any interaction by a person with specialist knowledge. For example, it is no longer necessary to manually set positive points as advance information in the image of the instance, for example by clicking on the corresponding position, in order to select the instance for the segmenting. The method is thus also suitable for automated instance segmenting tasks of unknown objects.

### REFERENCE NUMERALS

10 system
12 apparatus for recognizing an instance of an object
14 robot
14a robot arm
16 control apparatus
18 working environment/hall
18a floor of the hall
20 pallet
22 goods package
22a to 22h instances of the goods packages
24 conveyor belt
26 camera apparatus
28 monitoring and control unit
30 image sensor
32 region of the working environment
34 starting region/QR code

1. A method for recognizing at least one instance of an object during a work sequence in a working environment, said method comprising the steps of:
recording an image of the working environment by means of a camera apparatus,
transmitting the image to a monitoring and control unit,
detecting a predefined or predefinable starting region for the segmenting of the instance in the image, whereby the instance is selected by the monitoring and control unit for the segmenting,
segmenting the instance in the image, starting from the starting region that is detected and that is arranged within the instance, by means of the monitoring and control unit and recognizing the segmented instance.

2. The method according to claim 1, wherein the detecting of the starting region in the image of the working environment takes place automatically by the monitoring and control unit.

3. The method according to claim 1, wherein the segmenting of the instance in the image takes place in a fully automatic and interaction-free manner.

4. The method according to claim 1, wherein the starting region in the image of the working environment comprises an area that is smaller than the area of the instance in the image of the working environment, in particular wherein the area of the starting region.

5. The method according to claim 1, wherein the starting region and the instance in the image of the working environment differ in the shape and/or the brightness distribution and/or the histogram of the brightness values and/or the cumulative histogram of the brightness values.

6. The method according to claim 1, wherein the starting region is a coded marking.

7. The method according to claim 1, wherein the monitoring and control unit comprises a neural network, wherein the neural network receives an object description of the starting region, decodes and converts the object description into an image representation, and detects the starting region for the segmenting of the instance on the basis of the object description converted into an image representation in the image of the working environment.

8. The method according to claim 1, wherein a predefined orientation and/or a predefined position of the detected starting region at the instance is/are used as additional information for the segmenting of the instance.

9. The method according to claim 1, wherein the image is a two-dimensional or a three-dimensional image of the working environment.

10. The method according to claim 1, furthermore comprising the determination of geometric features of the segmented instance.

11. An apparatus for recognizing at least one instance of an object during a work sequence in a working environment,
wherein the apparatus has a camera apparatus and a monitoring and control unit,
wherein the camera apparatus is configured to record an image of the working environment and to transmit it to the monitoring and control unit,
wherein the monitoring and control unit is configured to detect a predefined or predefinable starting region in the image of the working environment and, as a result, to select an instance for the segmenting of the instance, and
wherein the monitoring and control unit is configured to recognize the instance in the image by means of a segmenting, wherein the instance is segmented, starting from the starting region that is detected and that is arranged within the instance.

12. The apparatus according to claim 11, wherein the monitoring and control unit is furthermore configured to determine geometric features of the segmented instance.

13. A system for controlling a work sequence in a working environment, said system comprising an apparatus for recognizing at least one instance of an object during a work sequence in a working environment, and,
wherein the apparatus has a camera apparatus and a monitoring and control unit, wherein the camera apparatus is configured to record an image of the working environment and to transmit it to the monitoring and control unit, wherein the monitoring and control unit is configured to detect a predefined or predefinable starting region in the image of the working environment and, as a result, to select an instance for the segmenting of the instance, and wherein the monitoring and control unit is configured to recognize the instance in the image by means of a segmenting, wherein the instance is segmented, starting from the starting region that is detected and that is arranged within the instance,
wherein the working apparatus is configured to perform steps of the work sequence, and a control apparatus that is configured to calculate control parameters for the working apparatus based on geometric features of an instance transmitted by the apparatus and to transmit said control parameters to the working apparatus.

14. The system according to claim 13, wherein the control apparatus is configured to calculate the control parameters from geometric features, which are transmitted by the apparatus, by means of a neural network.

15. The method according to claim 4, wherein the area of the starting region is smaller than 80% of the area of the instance.

16. The method according to claim 15, wherein the area of the starting region is smaller than 60% of the area of the instance.

17. The method according to claim 6, wherein the coded marking is a barcode or a QR code.

18. The method according to claim 7, wherein the neural network receives a text-based and/or audio-based object description of the starting region.

19. The method according to claim 10, wherein the determination of geometric features comprises the position and/or extent and/or orientation of the segmented instance.

20. The method according to claim 10,
wherein the determined geometric features are transmitted to a working apparatus.

21. The apparatus according to claim 11, wherein the monitoring and control unit is configured to automatically detect the predefined or predefinable starting region in the image of the working environment.

22. The apparatus according to claim 11, wherein the segmenting of the instance in the image takes place in a fully automatic and interaction-free manner.

23. The apparatus according to claim 12, wherein the geometric features of the segmented instance comprise the position and/or extent and/or orientation.

24. The apparatus according to claim 12, wherein the geometric features are transmitted to a working apparatus.

25. The system according to claim 13, wherein the working apparatus is a robot.
